(19) United States
(12) Patent Application Publication
(10) Pub. No.: US 2024/0029215 A1
(43) Pub. Date: Jan. 25, 2024

(54) METHODS AND SYSTEMS FOR VIRTUAL IMAGE COMPENSATION AND EVALUATION

(71) Applicant: JADE BIRD DISPLAY (SHANGHAI) LIMITED, SHANGHAI (CN)

(72) Inventor: Xingtong JIANG, Shanghai (CN)

(21) Appl. No.: 18/351,897

(22) Filed: Jul. 13, 2023

(30) Foreign Application Priority Data
Jul. 19, 2022 (WO) PCT/CN2022/106483

(51) Int. Cl. G06T 5/00; G06T 19/00; G06T 7/00

(52) U.S. Cl. CPC G06T 5/006; G06T 19/006; G06T 7/0002

(57) ABSTRACT

A method for image compensation for a virtual image displayed by a near eye display based on a micro display projector includes acquiring a virtual image displayed by the near eye display, wherein the virtual image is formed by a source image emitted from the micro display projector; preprocessing image data of the virtual image to obtain preprocessed image data; acquiring a relationship between the source image and the virtual image; determining an image baseline value of the virtual image; and obtaining a compensation factor matrix comprising a compensation factor for each pixel in the source image, based on the relationship and the image baseline value.

### CROSS-REFERENCE TO RELATED APPLICATIONS

The present disclosure claims priority to and the benefits of PCT Application No. PCT/CN2022/106483, filed on Jul. 19, 2023, which is incorporated herein by reference in its entirety.

### TECHNICAL FIELD

The present disclosure generally relates to micro display technology, and more particularly, to a method and system for virtual image compensation and evaluation.

### BACKGROUND

Near-eye displays may be provided as an augmented reality (AR) display, a virtual reality (VR) display, a Head Up/Head Mount or other displays. Generally, a near-eye display usually comprises an image generator and an optical combiner which transfers a projected image from the image generator to human eyes. The optical combiner is a group of reflective and/or diffractive optics, such as freeform mirror/prism, birdbath, or cascaded mirrors, and/or grating coupler (waveguide). Furthermore, the projected image is a virtual image before human eyes. The image generator can be a micro LED based display, a LCOS (Liquid Crystal on Silicon) display, or a DLP (Digital Light Processing) display. The virtual image is rendered from the image generator and optical combiner to human eyes.

Uniformity is one key performance metric for displays, which is used to evaluate image quality. It normally refers to imperfections of a display matrix, and is called non-uniformity as well. Non-uniformity includes variation in global distribution, and local zones, which is also called mura. For near-eye displays such as AR/VR, a visual artefact such as mottled, bright, or black spot, or cloud appearance is also observable on the virtual image rendered in the display system. In the virtual image rendered in the AR/VR display, nonuniformity can be shown in luminance and/or chromaticity. Compared to traditional displays, the non-uniformity artefacts are much more obvious due to the closeness to human eyes. Therefore, a method for improving the virtual image quality is desired.

### SUMMARY OF THE DISCLOSURE

Embodiments of the present disclosure provide a method for compensating a virtual image displayed by a near eye display based on a micro display projector. The method includes acquiring a virtual image displayed by the near eye display, wherein the virtual image is formed by a source image emitted from the micro display projector; preprocessing image data of the virtual image to obtain preprocessed image data; acquiring a relationship between the source image and the virtual image; determining an image baseline value of the virtual image; and obtaining a compensation factor matrix comprising a compensation factor for each pixel in the source image, based on the relationship and the image baseline value.

Embodiments of the present disclosure further provide an apparatus. The apparatus includes a memory configured to store instructions; and one or more processors configured to execute the instructions to cause the apparatus to perform the above-mentioned method for compensating a virtual image displayed by a near eye display based on a micro display projector.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 shows a framework of a uniformization method for improving image quality, according to some embodiments of the present disclosure.

FIG. 2 shows a flowchart illustrating an exemplary compensation method, according to some embodiments of the present disclosure.

FIG. 3A, FIG. 3B, and FIG. 3C show an example of a full white test pattern, a captured virtual image in color, and a pseudo-color luminance distribution image, according to some embodiments of the present disclosure.

FIG. 4 shows a flowchart illustrating an exemplary preprocessing method, according to some embodiments of the present disclosure.

FIG. 5 shows an exemplary determined region of interest (ROI) from image data, according to some embodiments of the present disclosure.

FIG. 6 shows an exemplary image after distortion correction, according to some embodiments of the present disclosure.

FIG. 7 shows an example of pixel registration from a virtual image to a source image with a mapping ratio, according to some embodiments of the present disclosure.

FIG. 8 shows an example of an image histogram, according to some embodiments of the present disclosure.

FIG. 9 shows an example of a generated image with compensation in pseudo color, according to some embodiments of the present disclosure.

FIG. 10 illustrates another flowchart of an exemplary image compensation method, according to some embodiments of the present disclosure.

FIG. 11 shows an example of image non-uniformity in pseudo color, according to some embodiments of the present disclosure.

FIG. 12 illustrates a flowchart of an exemplary method for re-evaluating non-uniformity of an updated virtual image, according to some embodiments of the present disclosure.

FIG. 13A and FIG. 13B show an exemplary uniformity before and after compensation, according to some embodiments of the present disclosure.

FIG. 14A and FIG. 14B show an exemplary luminance distribution before and after compensation, according to some embodiments of the present disclosure.

FIG. 15 shows nine-point uniformity before and after compensation, according to some embodiments of the present disclosure.

FIG. 16 is a schematic diagram of an exemplary system according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Nonuniformity can be compensated to improve image quality, by developing and integrating uniformization (also referred to as demura) algorithm in a display driving system. Demura refers to a process for eliminating/suppressing visual artefacts and achieving relative uniformity for luminance and/or color in a display.

According to the present disclosure, compensation methods and systems for improving uniformity in near-eye displays are provided.

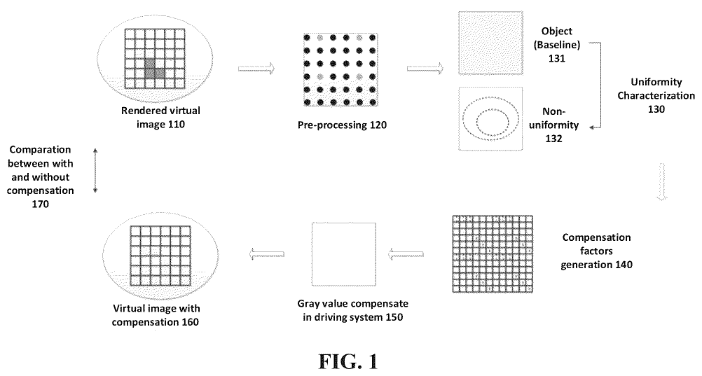

FIG. 1 shows a framework of a uniformization method for improving image quality, according to some embodiments of the present disclosure. Referring to FIG. 1, a rendered virtual image displayed by a near-eye display (NED)110 is acquired by an imaging light measuring device (LMD). After the virtual image is pre-processed (including a processing of registration) 120, a uniformity of the virtual image is characterized 130 for compensation calculation by comparing to a baseline 131 to obtain a non-uniformity 132. Compensation factors for a pixel matrix are generated 140, with consideration of a non-uniformity matrix and an objective matrix. Gray values of pixel matrix are finally adjusted 150, according to a compensation factor for each pixel of an image generator, to obtain a rendered virtual image with compensation 160. The rendered virtual image with compensation 160 can be re-evaluated. Finally, the rendered virtual image with compensation 160 is compared with the rendered virtual image without compensation 110 to determine a uniformity improvement quality (e.g., NU (non-uniformity) <=10%) 170.

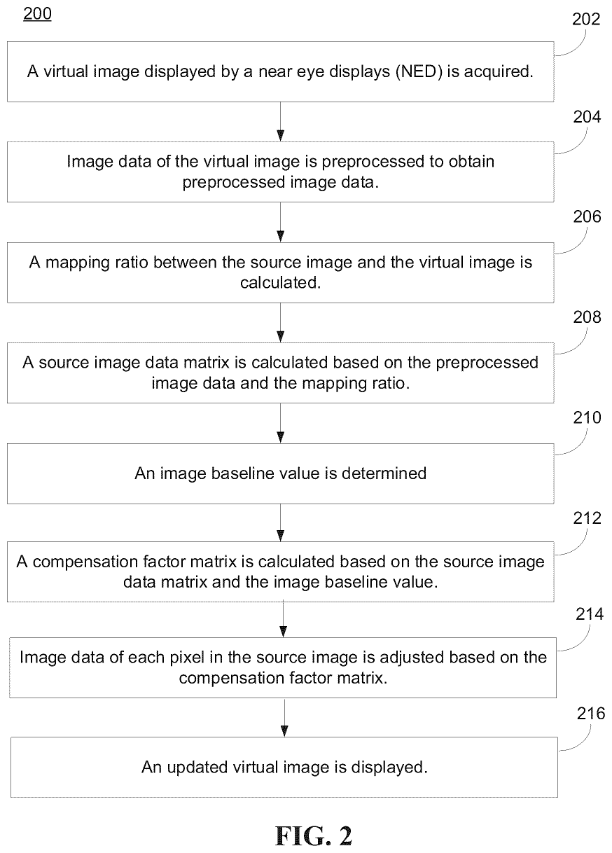

FIG. 2 shows a flowchart illustrating an exemplary compensation method 200, according to some embodiments of the present disclosure. Referring to FIG. 2, method 200 includes steps 202 to 216.

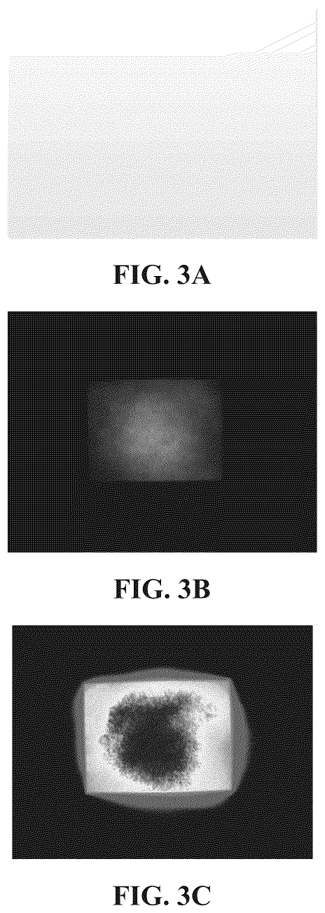

At step 202, a virtual image displayed by a near eye displays (NED) is acquired. The virtual image is rendered by the NED, and displayed by a micro display projector of the NED to human eyes. The virtual image is formed by a source image which is emitted from the micro display projector and transmitted toward the front of human eyes. To characterize the non-uniformity of the virtual image for further compensation calculation, the virtual image is captured by an imaging LMD (light measuring device). In some embodiments, the LMD can be a colorimeter or an imaging camera, such as a CCD (charge coupled device) or a CMOS (complementary metal oxide semiconductor). Grayscale and/or luminance distribution of the virtual image is obtained in a full view field of the virtual image. Therefore, gray values and/or luminance values of each pixel of the virtual image are obtained, also referred to as image data. A test pattern of full white can be applied in the measurement. In some embodiments, the source image is a full white image (e.g., a full white test pattern), and the virtual image is a full white image as well. Therefore, based on the full white test pattern, the calculation of compensation factors for a compensation model can be more accurate. In some embodiments, the source image includes a plurality of partial-on patterns, instead of a full pattern. The plurality of partial-on patterns are stacked together to form a full white pattern. For example, three partial-on patterns are rendered to NED in sequence. Finally, a full screen virtual image is obtained. In some embodiments, one or more images with various gray/luminance can be rendered in the NED. FIG. 3A shows an example of a full white test pattern, FIG. 3B shows a captured virtual image in color, and FIG. 3C shows a pseudo-color luminance image, according to some embodiments of the present disclosure. Referring to FIG. 3A, FIG. 3B and FIG. 3C, the virtual image is captured by a 2D colorimeter with NED lens.

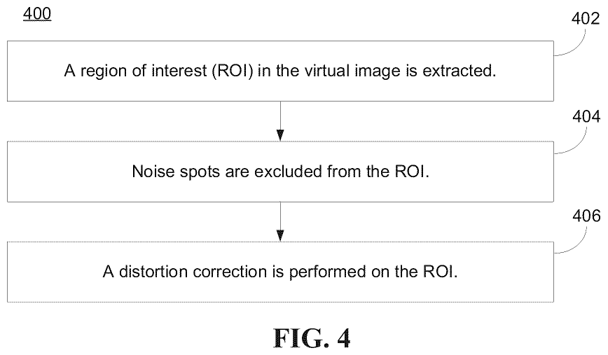

At step 204, image data of the virtual image is preprocessed to obtain preprocessed image data. The image data includes gray values and/or luminance values of an image. FIG. 4 shows a flowchart illustrating an exemplary preprocessing method 400, according to some embodiments of the present disclosure. Referring to FIG. 4, the preprocessing method 400 includes steps 402 to 406.

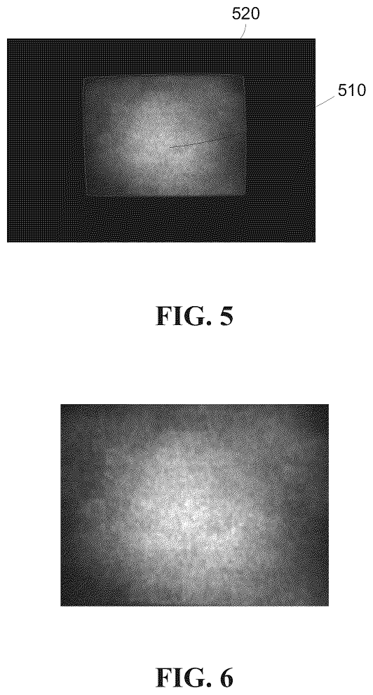

At step 402, a region of interest (ROI) in the virtual image is extracted. The image data in the ROI of the virtual image is subjected to preprocessing. In some embodiments, the ROI can be determined by a preset threshold. FIG. 5 shows an exemplary determined ROI 510 from the image data, according to some embodiments of the present disclosure. Referring to FIG. 5, ROI 510 for the full view field of virtual image is determined based on a predefined threshold. In some embodiments, the ROI is determined by comparing an average value of the image data with the threshold, and the average image data value in the region of interest is not less than the threshold. In some embodiments, the ROI is determined by comparing a value of image data for each pixel with the threshold. For example, the ROI can be determined according to Eq. 1:

Lₚᵢₓₑₗ≥L_{threshold} (Eq.1)
wherein the threshold L_{threshold} can be set according to an image histogram, and Lₚᵢₓₑₗ represents a value of image data of a pixel. For example, the threshold is set as a gray value that is less than ten percent of the whole gray scale (255), for example, the threshold is set as 225.

In some embodiments, the virtual image is divided into the ROI and a dark region around the ROI, for example, referring to FIG. 5, a region 520.

At step 404, noise spots are excluded from the ROI. In some embodiments, the noise spots are excluded from the ROI by evaluating an emitting area and background region of the virtual image.

At step 406, a distortion correction is performed on the ROI. In some embodiments, the pre-processing further includes image distortion correction. The captured virtual image is distorted with an LMD lens as well as a DUT (device under test) module. To obtain accurate distribution data, the captured image needs to be undistorted, that is, distortion corrected by remapping the geometric pixel matrix. Normally, the distortion is observed (e.g., a barrel distortion), and a reverse transformation is correspondingly applied to correct the distortion. In some embodiments, a distortion can be corrected by Eq. 2-1 and Eq. 2-2.

x_{corr}=x_{orig}(1+k₁r²+k₂r⁴+k₃r⁶) (Eq. 2-1)

y_{corr}=y_{orig}(1+k₁r²+k₂r⁴+k₃r⁶) (Eq. 2-2)
where (x_{corr}, y_{corr}) are the coordinates of a pixel after distortion correction, corresponding to original coordinates (x_{orig}, y_{orig}). The term r presents a distance of the pixel to a center of the virtual image. The term k₁, k₂, k₃ are coefficients of distortion parameters. In some embodiments, a tangential distortion can be also corrected. FIG. 6 shows an exemplary image after distortion correction, according to some embodiments of the present disclosure.

A relationship between the source image and the virtual image is acquired after step 204. Referring back to FIG. 2, the relationship between the source image and the virtual image can be acquired by the following steps 206 and 208.

At step 206, a mapping ratio between the source image and the virtual image is calculated. To accomplish the compensation through an image generator, a pixel registration is performed to map the captured virtual image to a matrix array of the image generator. In some embodiments, each pixel of image generator/source can be extracted by a method of evaluating a mapping ratio and full field size of the virtual image. In some embodiments, the pixels are identified by image processing such as morphology and feature extraction. The position of a pixel can be determined through a morphological image processing (e.g., dilation/erosion etc.).

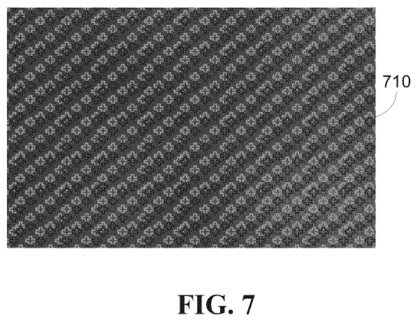

Since the virtual image is captured by a higher resolution imaging LMD, the virtual image is much larger than the source image. For example, the mapping ratio is 3 or 5 between the virtual image and the source image. FIG. 7 shows an example of pixel registration from a virtual image to a source image with mapping ratio 5, according to some embodiments of the present disclosure. Each unit zone 710 (shown as a cross) represents an extracted pixel of the source image. In some embodiments, the mapping ratio is determined by a full field size of the virtual image, a full field size of the source image, a dimension of the virtual image, and a dimension of the source image. For example, the mapping ratio is calculated by Eq. 3-1 to Eq. 3-3:

R=R₁/R₂ (Eq. 3-1)

R₁=D₁/FOV₁ (Eq. 3-2)

R₂=D₂/FOV₂ (Eq. 3-3)
wherein, R is the mapping ratio, D₁ is a dimension of an imaging LMD which is used to acquire the virtual image, FOV₁ is an active field of view of the imaging LMD, D₂ is an active emitting area of a micro light emitting array in the micro display projector, and FOV₂ is an active field of view of the micro display projector. In some embodiments, the micro display projector includes a micro display panel and a lens. The micro display panel includes a micro light emitting array which can form the active emitting area. For example, the micro display panel is a micro inorganic-LED (light-emitting diode) display panel, a micro-OLED (organic light-emitting diode) display panel, or a micro-LCD (liquid crystal display) display panel.

At step 208, a source image data matrix is calculated based on the preprocessed image data and the mapping ratio. The source image data matrix includes a same pixel dimension of the source image. In some embodiments, the source image data matrix is obtained by Eq. 4.

[M]_{orig}=[M₁]/R (Eq. 4)
where [M]_{orig} is the source image data, R is the mapping ratio, and M₁ is a preprocessed image data matrix consisting of the preprocessed image data.

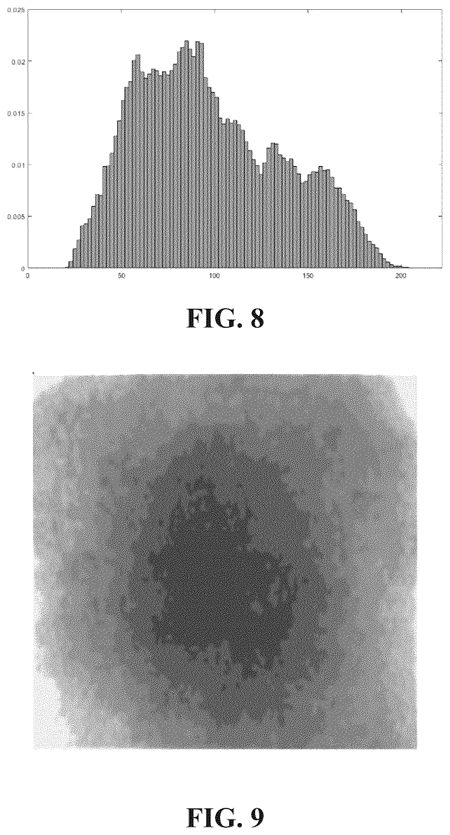

At step 210, an image baseline value is determined. To characterize the image uniformity and perform compensation, the image baseline value is needed to be set for a general global representation and compensation object. Therefore, the image baseline value is determined for a whole virtual image. In some embodiments, the image baseline value can be determined by analyzing the image histogram (e.g., proportion of pixels corresponding to each gray value). The gray distribution in the whole image is considered in the histogram method. FIG. 8 shows an example of an image histogram, according to some embodiments of the present disclosure. Referring to FIG. 8, a pixel number in proportion (i.e., vertical axis) corresponding to each gray value (i.e., horizontal axis) is shown. In some embodiments, the image baseline value is determined by the maximum proportion (i.e., the peak) of pixels. In some embodiments, the baseline value is determined by calculating an average gray value of all pixels. For example, the baseline value can be obtained by Eq. 5.

V_{baseline}=(Σᵢ₌₁ⁿGVᵢ)/n (Eq. 5)
where V_{baseline} is a baseline value, n is the number of pixels, and GVᵢ, is a gray value for each pixel.

At step 212, a compensation factor matrix is calculated based on the source image data matrix and the image baseline value. The compensation factor matrix includes a compensation factor for each pixel in the source image. In some embodiments, the compensation factor matrix for each pixel can be obtained by Eq. 6.

[M]_{comp}=[M]_{baseline}/[M]_{orig}−1 (Eq. 6)
wherein [M]_{comp} represents a compensation factor matrix (e.g., 640×480) for the image generator. [M]_{baseline} is a baseline matrix consistent of the image baseline value.

The compensation factor can be positive or negative. A positive compensation factor means that an original pixel value is pulled up to the baseline value with an increase. A negative compensation factor means the original pixel value is pulled down to the baseline value with a decrease.

Therefore, a compensation model (e.g., the compensation factor matrix) for improving the image quality is established. A compensation for the non-uniformity can be further performed with the compensation model. In some embodiments, the compensation model (e.g., the compensation factor matrix) can be stored in a hard disk of the display system, or in a memory of the micro display panel, such that the compensation can be performed to the whole display system.

In some embodiments, the compensation method 200 can further includes step 214.

At step 214, image data of each pixel for the virtual image is adjusted based on the compensation factor matrix. In some embodiments, the image data of each pixel in the source image is adjusted based on the compensation factor matrix. The source image is an image transmitted by the micro LED of the display device for forming a virtual image.

In some embodiments, adjusted image data of each pixel in the source image is obtained by Eq. 7:

GV_{comp}=round(GV_{orig}×([M]_{comp}+1)) (Eq. 7)
wherein GV_{comp} is an adjusted image data matrix comprising adjusted image data of each pixel, GV_{orig} is the source image data matrix comprising image data of each pixel in the source image, and [M]_{comp} is the compensation factor matrix.

In some embodiments, the image data includes the gray value of each pixel, for example, an original gray value for a pixel is 128. The corresponding compensation factor is 0.2. Therefore, the gray value after compensation is 153.6. With an integer function (e.g., round, or ceil/floor), the gray value after compensation is 154. In some embodiments, the compensation ability depends on the display driving system. In some embodiments, the gray value after compensation normally overflows an original gray value range (e.g., 0˜255). Therefore, a gray value range after compensation includes the original gray value range and an extension gray value range. For example, the gray value range after compensation is a range of 0 to 511 (e.g., with 9 bits). In some embodiments, gray values for some individual pixels are still beyond the gray value range after compensation. The gray value beyond the gray value range after compensation can be cut off at the boundary (e.g., at 0 or at 511). FIG. 9 shows an example of a generated image with compensation in pseudo color, according to some embodiments of the present disclosure. Referring to FIG. 9, comparing with FIG. 3C, the image with compensation is adjusted with gray values, and the uniformity is improved.

In some embodiments, the image data includes a luminance value of each pixel. The adjusted image data of each pixel in the source image is obtained by adjusting the luminance value of each pixel.

In some embodiments, the image data to the micro light emitting array, is adjusted based on the compensation factor matrix. In this example, the gray value of each pixel is adjusted to obtain an updated virtual image.

Therefore, in some embodiments, method 200 further includes a step 216 to display an updated virtual image.

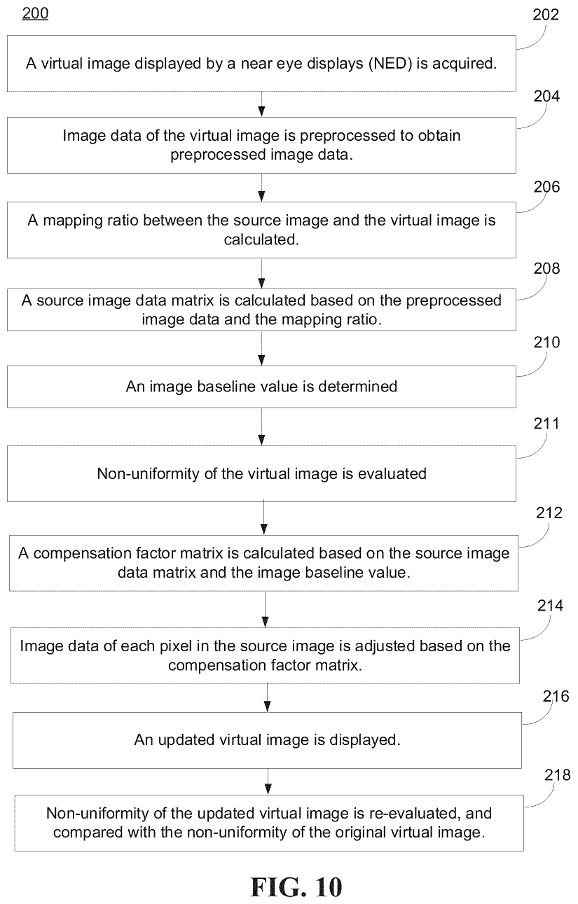

FIG. 10 illustrates another flowchart of the exemplary image compensation method 200, according to some embodiments of the present disclosure. As shown in FIG. 10, in order to review the quality of improvement of the compensation method, after step 210, method 200 further includes step 211.

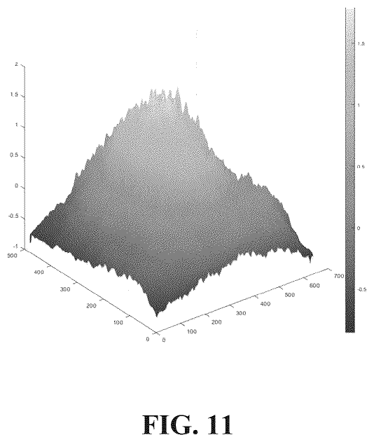

At step 211, non-uniformity of the virtual image is evaluated. Based on the image baseline value, the non-uniformity for the virtual image can be evaluated. A non-uniformity can be calculated according to Eq. 8:

[M]ₙₒₙ=([M]_{orig}−[M]_{baseline})/[M]_{baseline} (Eq. 8)
wherein [M]ₙₒₙ represents non-uniformity of an image, [M]_{orig} is a source image data matrix, and [M]_{baseline} is a baseline matrix consistent of the image baseline value. FIG. 11 shows an example of image non-uniformity in pseudo color, according to some embodiments of the present disclosure. In some embodiments, the nonuniformity can be directly evaluated before mapping the virtual image to source image matrix.

In some embodiments, method 200 can further include step 218.

At step 218, non-uniformity of the updated virtual image is re-evaluated, and compared with the non-uniformity of the original virtual image (i.e., the non-uniformity evaluated in step 211). Other steps in FIG. 10 are the same as those described above with reference to FIG. 2, which will not repeated herein.

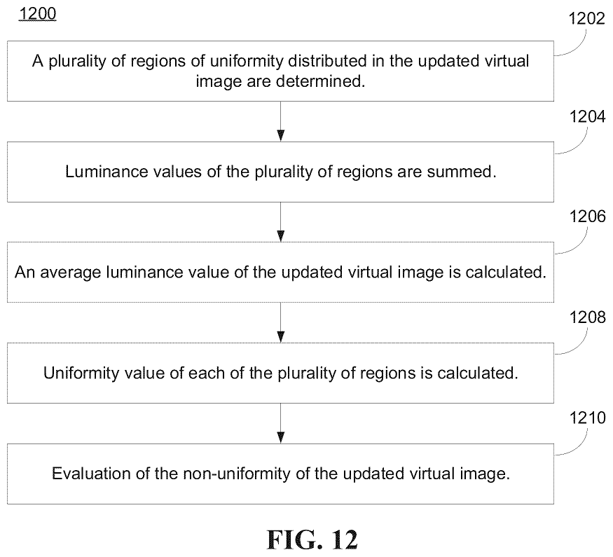

FIG. 12 illustrates a flowchart of an exemplary method 1200 for re-evaluating the non-uniformity of the updated virtual image, according to some embodiments of the present disclosure. As shown in FIG. 12, re-evaluating the non-uniformity of the updated virtual image includes steps 1202 to 1210.

At step 1202, a plurality of regions of uniformity distributed in the updated virtual image are determined. For example, the plurality of regions can be determined as 9 regions of uniformity which are uniformity distributed around the virtual image.

At step 1204, luminance values of the plurality of regions are summed. It is noted that, the luminance values can be represented by gray values.

At step 1206, an average luminance value Lₐᵥ of the updated virtual image is calculated. In some embodiments, the average luminance value of the updated virtual image is obtained by Eq. 9:

Lₐᵥ=S/N (Eq. 9)
wherein S is a sum of the luminance values of the plurality of regions, and N is the number of the regions, for example, N is equal to 9.

At step 1208, uniformity values of each of the plurality of regions is obtained. In some embodiments, a uniformity value Uₙ of each of the plurality of regions is obtained by Eq. 10:

Uₙ=Lₙ/Lₐᵥ (Eq. 10)
wherein Uₙ is the uniformity value at region n, Lₙ is a luminance value of the region n, and Lₐᵥ is an average luminance value of the updated virtual image. In this example, n is in a range of 1 to 9. Therefore, the method for re-evaluating the non-uniformity of the updated virtual image can be used to evaluate a global uniformity quantitatively.

In some embodiments, the method 1200 further includes a step 1210, calculating the non-uniformity (NU) of the updated virtual image with NU=1−Uₘₐₓ, where Uₘₐₓ is the maximum value in previous uniformity calculation among n regions.

In some embodiments, the plurality of regions are determined in the original virtual image, and uniformity values of regions in the original virtual image are calculated. Then the non-uniformity of each region of the updated virtual image is compared with the non-uniformity of the same region of the original virtual image.

In some embodiments, after comparing the non-uniformity of the original virtual image and the non-uniformity of the updated virtual image, a virtual image with a higher uniformity is finally displayed.

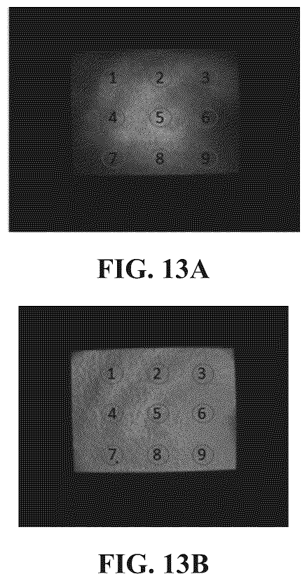

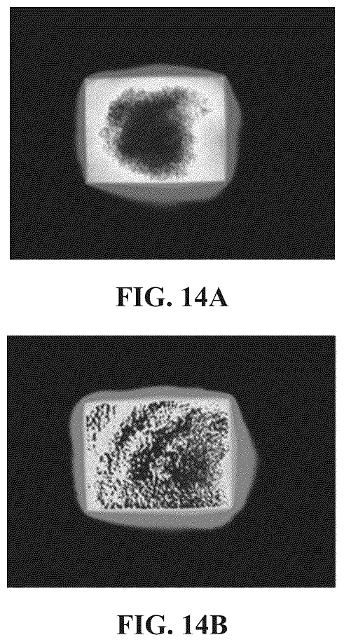

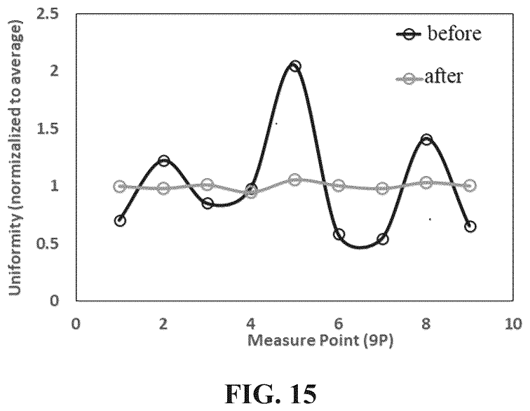

FIG. 13A and FIG. 13B show an exemplary uniformity comparison before and after compensation, according to some embodiments of the present disclosure. FIG. 13A shows the captured virtual image before compensation, and FIG. 13B shows the captured virtual image after compensation. FIG. 14A and FIG. 14B show an exemplary corresponding luminance distribution before and after compensation, according to some embodiments of the present disclosure. FIG. 14A shows the luminance distribution before compensation, and FIG. 14B shows the luminance distribution after compensation. As shown in FIG. 13A, FIG. 13B, FIG. 14A, and FIG. 14B, the uniformity and luminance distribution are improved significantly. FIG. 15 shows nine-point uniformity before and after compensation, according to some embodiments of the present disclosure. Referring to FIG. 15, the uniformity values at the nine regions are plotted. FIG. 15 shows that the fluctuation of uniformity in the image distribution has been significantly alleviated and is close to ideal smoothness (i.e., uniformity value being equal to 1). The image quality has been dramatically improved after the compensation.

With the uniformization/demura algorithm, the image quality of the virtual image rendered in NEDs is dramatically improved, and the visual artefact can be effectively eliminated after compensation.

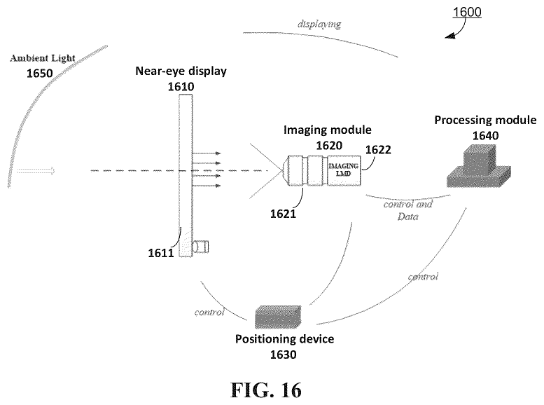

FIG. 16 is a schematic diagram of an exemplary system 1600 according to some embodiments of the present disclosure. As shown in FIG. 16, system 1600 is provided to improve uniformity of a virtual image rendered in a near-eye display, and can perform the above-mentioned compensation method 200. System 1600 includes a near-eye display (NED) 1610 for displaying images before human eyes, an imager provided as an imaging module 1620, a positioner provided as a positioning device 1630, and a processor provided as a processing module 1640. Additionally, ambient light can be provided by an ambient light module 1650. Near-eye display 1610 can be provided as an AR (augmented reality) display, VR (virtual reality) display, Head-Up/Head-Mount display or other displays. Positioning device 1630 is provided to set an appropriate spatial relation between near-eye display (NED) 1610 and imaging module 1620. For example, positioning device 1630 is configured to set a distance between near-eye display 1610 and imaging module 1620 in a range of 10 mm-25 mm. Positioning device 1630 can further adjust the relative position (e.g., the distance and spatial position) of near-eye display 1610 and imaging module 1620. Imaging module 1620 is configured to emulate the human eye to measure display optical characteristics and to observe display performance. In some embodiments, imaging module 1620 can include an array light measuring device (LMD) 1622 and a near-eye display (NED) lens 1621. For example, LMD 1622 can be a colorimeter or an imaging camera, such as a CCD (charge coupled device) or a CMOS (complementary metal oxide semiconductor). Near-eye display (NED) lens 1621 of imaging module 1620 is provided with a front aperture having a small diameter of 1 mm-6 mm. Therefore, near-eye display (NED) lens 1621 can provide a wide view field (e.g., 60-180 degrees) in front, and near-eye display lens 1621 is configured to emulate a human eye to observe near-eye display 1610. The optical property of the virtual image is measured by imaging module 1620 based on positioning device 1630.

In some embodiments, near-eye display 1610 can include an image generator 1611 also referred to herein as an image sourcer and an optical combiner also referred to herein as image optics (not shown in FIG. 16). Image generator 1611 can be a micro display such as a micro-LED, micro-OLED, LCOS, or DLP display, and can be configured to form a light engine with an additional projector lens. In some embodiments, the micro display projector includes a micro display panel and a plurality of lens. The micro display panel includes a micro light emitting array which can form an active emitting area. For example, the micro display panel is a micro inorganic-LED display panel, a micro OLED display panel, or a micro LCD display panel. The projected image from the light engine through designed optics is transferred to human eyes through the optical combiner. The optics of the optical combiner can be reflective and/or diffractive optics, such as a free form mirror/prism, birdbath or cascaded mirrors, grating coupler (waveguide), etc.

Processing module 1640 is configured to calculate a compensation factor and evaluate the uniformity/non-uniformity, etc. In some embodiments, processing module 1640 can be included in a computer or a server. In some embodiments, processing module 1640 can be deployed in the cloud, which is not limited herein.

In some embodiments, a driver provided as a driving module (not shown in FIG. 16) can be further provided to compensate image generator 1611. The compensation factors are calculated in processing module 1640, and then transferred to the driving module. Therefore, with system 1600, a compensation method can be performed. The drive system can be coupled to communicate with near-eye display 1610, specifically to communicate with image generator 1611 of near-eye display 1610. For example, the driving module can be configured to adjust the gray values of image generator 1611. When the driving system including display driving and a function of compensation (gray value adjustment in image processing) is integrated in the near-eye display, the data of compensation factors from processing module 1640 can be transferred to the near-eye display system 1610.

In some embodiments, for example for an AR application, ambient light is provided from ambient light module 1650. The ambient light module 1650 is configured to generate a uniform light source with corresponding color (such as D65), which can support a measurement taken under an ambient light background, and simulation of various scenarios such as daylight, outdoor, or indoor.

The embodiments may further be described using the following clauses:
1. A method for compensating a virtual image displayed by a near eye display based on a micro display projector, comprising:
acquiring a virtual image displayed by the near eye display, wherein the virtual image is formed by a source image emitted from the micro display projector;
preprocessing image data of the virtual image to obtain preprocessed image data;
acquiring a relationship between the source image and the virtual image;
determining an image baseline value of the virtual image; and
obtaining a compensation factor matrix comprising a compensation factor for each pixel in the source image, based on the relationship and the image baseline value.
2. The method according to clause 1, wherein acquiring a relationship between the source image and the virtual image further comprises:
calculating a mapping ratio between the source image and the virtual image;
calculating a source image data matrix based on the preprocessed image data and the mapping ratio, wherein the source image data matrix comprises a same pixel dimension of the source image; and
determining the source image data matrix to represent the relationship between the source image and the virtual image.
3. The method according to clause 1, wherein the virtual image is acquired by an image light measuring device.
4. The method according to clause 1, wherein the source image is a full white image.
5. The method according to clause 4, wherein the source image comprises a plurality of partial-on patterns, and the partial-on patterns are stacked to form the full white image.
6. The method according to clause 1, wherein preprocessing image data of the virtual image to obtain preprocessed image data further comprises:
determining a region of interest in the virtual image; and
processing image data in the region of interest.
7. The method according to clause 6, wherein the region of interest is determined by a preset threshold, wherein an average image data value in the region of interest is not less than the preset threshold.
8. The method according to clause 7, wherein an image data value of each pixel in the region of interest is not less than the preset threshold.
9. The method according to clause 7, wherein the virtual image is divided into the region of interest and a dark region around the region of interest.
10. The method according to clause 6, wherein processing image data in the region of interest further comprises:
excluding noise spots from the region of interest; and
correcting distortion of the virtual image.
11. The method according to clause 10, wherein the distortion of the virtual image is corrected by:

x_{corr}=x_{orig}(1+k₁r²+k₂r⁴+k₃r⁶)

y_{corr}=y_{orig}(1+k₁r²+k₂r⁴+k₃r⁶);
wherein (x_{corr}, y_{corr}) are coordinates of a pixel in the virtual image after distortion correction, corresponding to original coordinates (x_{orig}, y_{orig}); r presents a distance of the pixel to a center of the virtual image; and k₁, k₂, k₃ are coefficients of distortion parameters.
12. The method according to clause 2, wherein the mapping ratio is determined by a full field size of the virtual image, a full field size of the source image, a dimension of the virtual image, and a dimension of the source image.
13. The method according to clause 12, wherein the mapping ratio is calculated by:
R=R₁/R₂, wherein R₁=D₁/FOV₁, R₂=D₂/FOV₂, R is the mapping ratio, D₁ is a dimension of an imaging light measuring device (LMD) which is used to acquire the virtual image, FOV₁ is an active field of view of the imaging LMD, D₂ is an active emitting area of a micro light emitting array in the micro display projector, and FOV₂ is an active field of view of the micro display projector.
14. The method according to clause 1, wherein determining the image baseline value of the virtual image further comprises:
acquiring an image histogram of the virtual image data; and
determining a maximum proportion value in the image histogram as the image baseline value.
15. The method according to clause 1, wherein determining the image baseline value of the virtual image further comprises:
calculating an average gray value of all pixels in the virtual image; and
determining the average gray value as the image baseline value.
16. The method according to clause 2, wherein the source image data matrix is obtained by:

[M]_{orig}=[M₁]/R,
wherein [M]_{orig} is the source image data, R is the mapping ratio, and M₁ is a preprocessed image data matrix of the preprocessed image data.
17. The method according to clause 16, wherein the compensation factor matrix is obtained by:

[M]_{comp}=([M]_{baseline}/[M]_{orig})−1;
wherein [M]_{comp} is the compensation factor matrix, and [M]_{baseline} is a baseline matrix of the image baseline value.
18. The method according to clause 2, further comprising:
adjusting image data of each pixel for the virtual image based on the compensation factor matrix.
19. The method according to clause 18, wherein adjusting image data of each pixel for the virtual image based on the compensation factor matrix comprises:
adjusting image data of each pixel in the source image based on the compensation factor matrix.
20. The method according to clause 19, wherein the image data of each pixel in the source image is adjusted by:

GV_{comp}=round(GV_{orig}×([M]_{comp}+1));
wherein GV_{comp} is an adjusted image data matrix comprising adjusted image data of each pixel, GV_{orig} is the source image data matrix, and [M]_{comp} is the compensation factor matrix.
21. The method according to clause 18, wherein the micro display projector comprises a micro display panel and a lens, and the micro display panel comprises a micro light emitting array, and adjusting image data of each pixel for the virtual image based on the compensation factor matrix comprises:
adjusting image data of each pixel of the micro light emitting array based on the compensation factor matrix.
22. The method according to any one of clauses 1 to 21, wherein the image data comprises a gray value or a luminance value.
23. The method according to any one of clauses 18 to 22, further comprising displaying an updated virtual image.
24. The method according to any one of clauses 1 to 20, wherein the micro display projector comprises a micro display panel and a lens, and the micro display panel comprises a micro light emitting array.
25. The method according to clause 24, wherein the micro display panel is one of a micro inorganic-LED (light-emitting diode) display panel, a micro-OLED (organic light-emitting diode) display panel, a DLP (Digital Light Processing) display panel, or a micro-LCD (liquid crystal display) display panel.
26. The method according to any one of clauses 1 to 25, wherein the near-eye display is one of an augmented reality display, a virtual reality display, a Head-Up display, or a Head-Mount display.
27. A method for evaluating compensation of a virtual image displayed by a near eye display based on a micro display projector, comprising:
acquiring a first virtual image displayed by the near eye display, wherein the virtual image is formed by a source image emitted from the micro display projector;
preprocessing image data of the first virtual image to obtain preprocessed image data;
acquiring a relationship between the source image and the virtual image;
determining an image baseline value of the first virtual image;
evaluating non-uniformity of the first virtual image;
obtaining a compensation factor matrix comprising a compensation factor for each pixel in the source image, based on the relationship and the image baseline value;
adjusting image data of each pixel for the first virtual image based on the compensation factor matrix, and displaying a second virtual image;
re-evaluating non-uniformity of the second virtual image; and
comparing the non-uniformity of the second virtual image with the non-uniformity of the first virtual image.
28. The method according to clause 27, wherein acquiring a relationship between the source image and the virtual image further comprises:
calculating a mapping ratio between the source image and the virtual image; and,
calculating a source image data matrix based on the preprocessed image data and the mapping ratio, wherein the source image data matrix comprises a same pixel dimension of the source image; and
determining the source image data matrix to represent the relationship between the source image and the virtual image.
29. The method according to clause 27, wherein the non-uniformity of the first virtual image is calculated by:

[M]ₙₒₙ=([M]_{orig}−[M]_{baseline})/[M]_{baseline};
wherein [M]ₙₒₙ is the non-uniformity of the first virtual image, [M]_{orig} is the source image data, and [M]_{baseline} is a baseline matrix consistent of the image baseline value.
30. The method according to any one of clauses of 27 to 29, wherein re-evaluating the non-uniformity of the second virtual image further comprising:
determining a plurality of regions of uniformity distributed in the second virtual image;
summing luminance values of the plurality of regions;
calculating an average luminance value of the second virtual image based on:

Lₐᵥ=S/N,
wherein S is the sum of the luminance values of the plurality of regions, and N is a number of the regions; and
obtaining uniformity values of each of the plurality of regions by:

Uₙ=Lₙ/Lₐᵥ,

wherein Uₙ is a uniformity value at a region n, Lₙ is a luminance value of the region n, and Lₐᵥ is the average luminance value of the second virtual image.
31. The method according to clause 30, further comprising:
   evaluating the non-uniformity of the second virtual image by NU=1−Uₘₐₓ, wherein NU is the non-uniformity of the second virtual image, and Uₘₐₓ is a maximum value of the uniformity values among the N regions.
32. The method according to clause 30 or 31, wherein evaluating non-uniformity of the first virtual image further comprises:
   determining the plurality of regions in the first virtual image; and
   calculating uniformity values of each of the plurality of regions in the first virtual image; and
comparing the non-uniformity of the second virtual image with the non-uniformity of the first virtual image further comprises:
   comparing the non-uniformity of each of the plurality of regions of the second virtual image with the non-uniformity of the same region of the plurality of regions of the first virtual image.
33. The method according to clause 27, wherein adjusting image data of each pixel for the virtual image based on the compensation factor matrix comprises:
adjusting image data of each pixel in the source image based on the compensation factor matrix.
34. The method according to clause 27, wherein the micro display projector comprises a micro display panel and a lens, and the micro display panel comprises a micro light emitting array, and adjusting image data of each pixel for the virtual image based on the compensation factor matrix comprises:
adjusting image data of each pixel of the micro light emitting array based on the compensation factor matrix.
35. An apparatus for compensating a virtual image displayed by a near eye display based on a micro display projector, the apparatus comprising:
a memory configured to store instructions; and
one or more processors configured to execute the instructions to cause the apparatus to perform the method according to any one of clauses 1 to 26.
36. An apparatus for evaluating compensation of a virtual image displayed by a near eye display based on a micro display projector, the apparatus comprising:
a memory configured to store instructions; and
one or more processors configured to execute the instructions to cause the apparatus to perform the method according to any one of clauses 27 to 34.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for compensating a virtual image displayed by a near eye display based on a micro display projector, comprising:
acquiring a virtual image displayed by the near eye display, wherein the virtual image is formed by a source image emitted from the micro display projector;
preprocessing image data of the virtual image to obtain preprocessed image data;
acquiring a relationship between the source image and the virtual image;
determining an image baseline value of the virtual image; and
obtaining a compensation factor matrix comprising a compensation factor for each pixel in the source image, based on the relationship and the image baseline value.

2. The method according to claim 1, wherein acquiring a relationship between the source image and the virtual image further comprises:
calculating a mapping ratio between the source image and the virtual image;
calculating a source image data matrix based on the preprocessed image data and the mapping ratio, wherein the source image data matrix comprises a same pixel dimension of the source image; and
determining the source image data matrix to represent the relationship between the source image and the virtual image.

3. The method according to claim 1, wherein the virtual image is acquired by an image light measuring device.

4. The method according to claim 1, wherein the source image is a full white image.

5. The method according to claim 4, wherein the source image comprises a plurality of partial-on patterns, and the partial-on patterns are stacked to form the full white image.

6. The method according to claim 1, wherein preprocessing image data of the virtual image to obtain preprocessed image data further comprises:
determining a region of interest in the virtual image; and
processing image data in the region of interest.

7. The method according to claim 6, wherein processing image data in the region of interest further comprises:
excluding noise spots from the region of interest; and
correcting distortion of the virtual image.

8. The method according to claim 7, wherein the distortion of the virtual image is corrected by:
x_{corr}=x_{orig}(1+k₁r²+k₂r⁴+k₃r⁶)
y_{corr}=y_{orig}(1+k₁r²+k₂r⁴+k₃r⁶);
wherein (x_{corr}, y_{corr}) are coordinates of a pixel in the virtual image after distortion correction, corresponding to original coordinates (x_{orig}, y_{orig}); r presents a distance of the pixel to a center of the virtual image; and k₁, k₂, k₃ are coefficients of distortion parameters.

9. The method according to claim 1, wherein the micro display projector comprises a micro display panel and a lens, and the micro display panel comprises a micro light emitting array.

10. The method according to claim 9, wherein the micro display panel is one of a micro inorganic-LED (light-emitting diode) display panel, a micro-OLED (organic light-emitting diode) display panel, a DLP (Digital Light Processing) display panel, or a micro-LCD (liquid crystal display) display panel.

11. The method according to claim 1, wherein the near-eye display is one of an augmented reality display, a virtual reality display, a Head-Up display, or a Head-Mount display.

12. An apparatus for compensating a virtual image displayed by a near eye display based on a micro display projector, the apparatus comprising:
a memory configured to store instructions; and
one or more processors configured to execute the instructions to cause the apparatus to perform a method for compensating a virtual image, the method comprises:
acquiring a virtual image displayed by the near eye display, wherein the virtual image is formed by a source image emitted from the micro display projector;
preprocessing image data of the virtual image to obtain preprocessed image data;
acquiring a relationship between the source image and the virtual image;
determining an image baseline value of the virtual image; and
obtaining a compensation factor matrix comprising a compensation factor for each pixel in the source image, based on the relationship and the image baseline value.

13. The apparatus according to claim 12, wherein acquiring a relationship between the source image and the virtual image further comprises:
calculating a mapping ratio between the source image and the virtual image;
calculating a source image data matrix based on the preprocessed image data and the mapping ratio, wherein the source image data matrix comprises a same pixel dimension of the source image; and
determining the source image data matrix to represent the relationship between the source image and the virtual image.

14. The apparatus according to claim 12, wherein the virtual image is acquired by an image light measuring device.

15. The apparatus according to claim 12, wherein the source image is a full white image.

16. The apparatus according to claim 15, wherein the source image comprises a plurality of partial-on patterns, and the partial-on patterns are stacked to form the full white image.

17. The apparatus according to claim 12, wherein preprocessing image data of the virtual image to obtain preprocessed image data further comprises:
determining a region of interest in the virtual image; and
processing image data in the region of interest.

18. The apparatus according to claim 17, wherein processing image data in the region of interest further comprises:
excluding noise spots from the region of interest; and
correcting distortion of the virtual image.

19. The apparatus according to claim 18, wherein the distortion of the virtual image is corrected by:
x_{corr}=x_{orig}(1+k₁r²+k₂r⁴+k₃r⁶)
y_{corr}=y_{orig}(1+k₁r²+k₂r⁴+k₃r⁶);
wherein (x_{corr}, y_{corr}) are coordinates of a pixel in the virtual image after distortion correction, corresponding to original coordinates (x_{orig}, y_{orig}); r presents a distance of the pixel to a center of the virtual image; and k₁, k₂, k₃ are coefficients of distortion parameters.

20. The apparatus according to claim 12, wherein the near-eye display is one of an augmented reality display, a virtual reality display, a Head-Up display, or a Head-Mount display
